(19) United States
(12) Patent Application Publication
(10) Pub. No.: US 2016/0274817 A1
(43) Pub. Date: Sep. 22, 2016

(54) STORAGE DEVICE, SYSTEM, AND METHOD

(71) Applicant: KABUSHIKI KAISHA TOSHIBA, Tokyo (JP)

(72) Inventors: Yasuto Aramaki, Kawasaki Kanagawa (JP); Taichiro Yamanaka, Hino Tokyo (JP); Yoshiyuki Kudoh, Kawasaki Kanagawa (JP); Hiroki Udagawa, Kawasaki Kanagawa (JP)

(21) Appl. No.: 14/730,859

(22) Filed: Jun. 4, 2015

Related U.S. Application Data
(60) Provisional application No. 62/135,219, filed on Mar. 19, 2015.

(51) Int. Cl. G06F 3/06

(52) U.S. Cl. CPC G06F 3/0637; G06F 3/0622; G06F 3/0673

(57) ABSTRACT

According to one embodiment, a processor of a storage device is configured: to receive an instruction of setting a portion of an area of a storage medium from a first state to a second state and receive first information defining a condition of setting the portion of the area from the second state to the first state again from a first host device among a plurality of host devices; to set the portion of the area to the second state in response to the instruction; and to set, after the portion of the area is set to the second state in response to the instruction, the portion of the area from the second state to first state again based on the first information.

### CROSS-REFERENCE TO RELATED APPLICATIONS

This application is based upon and claims the benefit of priority from U.S. Provisional Application No. 62/135,219, filed on Mar. 19, 2015; the entire contents of which are incorporated herein by reference.

### FIELD

Embodiments described herein relate generally to a storage device, a system, and a method

### BACKGROUND

Conventionally, there has been known a technique where an access restriction state of a storage device is controlled by a host device which is connected to the storage device in a one-to-one correspondence manner.

In a configuration where a storage device is communicatably connected to a plurality of host devices, it is desirable to appropriately control the access restriction state of the storage device.

### BRIEF DESCRIPTION OF THE DRAWINGS

FIG. 1 is an exemplary diagram illustrating a configuration of a system including a storage device according to an embodiment;

FIG. 2 is an exemplary block diagram illustrating a hardware configuration of the storage device and a host device in the embodiment;

FIG. 3 is an exemplary block diagram illustrating a functional configuration of the storage device and the host device in the embodiment;

FIG. 4 is an exemplary diagram illustrating a table used in the storage device in the embodiment;

FIG. 5 is an exemplary sequence diagram for explaining an outline of processes executed by the storage device and the host device in the embodiment;

FIG. 6 is an exemplary flowchart for explaining a process of releasing restriction of access to a storage medium in response to an instruction from the host device, by the storage device in the embodiment; and

FIG. 7 is an exemplary flowchart for explaining a process of controlling an access restriction state of the storage medium by using a table, by the storage device in the embodiment.

### DETAILED DESCRIPTION

In general, according to one embodiment, a storage device includes a storage medium, an interface, and a processor. The interface is configured to be connectable to a plurality of host devices. The processor is configured to be capable of setting a portion of an area of the storage medium to a first state where access is restricted or to a second state where restriction of the access is released. The processor is configured: to receive, from a first host device among the host devices, an instruction of setting the portion of the area to the second state and first information defining a condition of setting the portion of the area from the second state to the first state again; to set the portion of the area to the second state in response to the instruction; and to set, after the portion of the area is set to the second state, the portion of the area from the second state to the first state again based on the first information.

Exemplary embodiments of a storage device, system, and method will be explained below in detail with reference to the accompanying drawings. The present invention is not limited to the following embodiments.

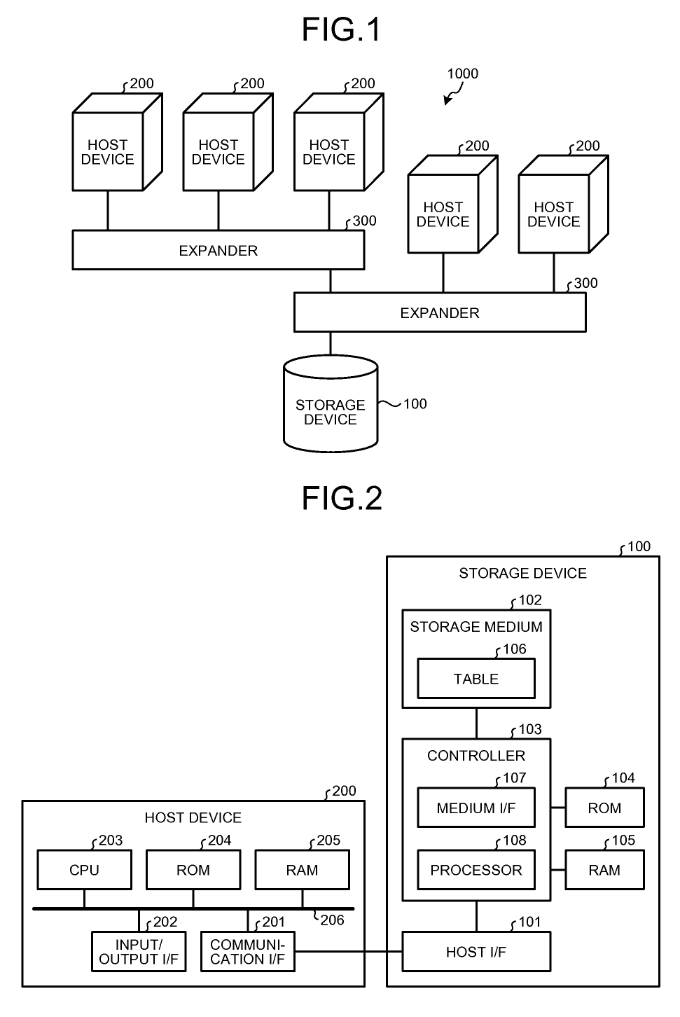

First, an example of a configuration of a system 1000 including a storage device 100 according to a embodiment will be described with reference to FIG. 1.

As illustrated in FIG. 1, the system 1000 of the embodiment includes a storage device 100 and a plurality of host devices 200. The storage device 100 and the host devices 200 are communicatably connected to each other via expanders 300. Herein, the expander 300 is a relay device configured to relay communication executed between the storage device 100 and the host devices 200.

The communication executed between the storage device 100 and the host devices 200 is, for example, serial communication corresponding to SAS (Serial Attached SCSI). FIG. 1 illustrates an example where the number of storage devices 100, the number of host devices 200, and the number of expanders 300 are one, five, and two, respectively. However, the number of storage devices 100, the number of host devices 200, and the number of expanders 300 are not limited to the example illustrated in FIG. 1.

Next, an example of a hardware configuration of the storage device 100 and a host device 200 according to the embodiment will be described with reference to FIG. 2. In FIG. 2, the expanders 300 illustrated in FIG. 1 are omitted in illustration.

As illustrated in FIG. 2, the storage device 100 of the embodiment includes a host I/F (interface) 101, a storage medium 102, a controller 103, a ROM (Read Only Memory) 104, and a RAM (Random Access Memory) 105.

The host I/F 101 is an interface to connect the storage device 100 to the host device 200 (via the expanders 300 of FIG. 1). The storage medium 102 is a storage device which stores various types of data. Herein, in the embodiment, a table 106 is stored in the storage medium 102. The table 106 is configured to store therein a threshold value for relocking and an accumulated value which are described later. The table 106 is stored, for example, in a system area of the storage medium 102.

The controller 103 is a system LSI (Large Scale Integration) including a medium I/F 107 and a processor 108. The controller 103 is implemented as a system-on-a-chip (SOC) where a plurality of elements are integrated into a single chip. The medium I/F 107 is an interface for connecting the controller 103 to the storage medium 102. The processor 108 includes an arithmetic processing unit such as a CPU (Central Processing Unit) and executes various types of programs to control components of the storage device 100.

The ROM 104 is a non-volatile memory storing various types of programs, which are to be executed by the processor 108, and the like. The RAM 105 is a main memory providing a work area when the processor 108 executes the various types of programs. The programs which are to be executed by the processor 108 may be stored in the storage medium 102.

Subsequently with reference to FIG. 2, an example of a hardware configuration of the host devices 200 according to the embodiment will be described.

The host device 200 of the embodiment has the same hardware configuration as a general computer. Namely, as illustrated in FIG. 2, the host device 200 includes a communication I/F 201, an input/output I/F 202, a CPU 203, a ROM 204, and a RAM 205. These hardware components are connected to a bus 206.

The communication I/F 201 is an interface to connect the host device 200 to the storage device 100 (via the expanders 300 of FIG. 1). The input/output I/F 202 is an interface to connect an output device such as a display, an input device such as a keyboard, and the like to the host device 200.

The CPU 203 is an arithmetic processing unit configured to execute various types of programs to control components of the host device 200. The ROM 204 is a non-volatile memory storing therein various types of programs which are to be executed by the CPU 203. The RAM 205 is a main memory providing a work area when the CPU 203 executes the various types of programs.

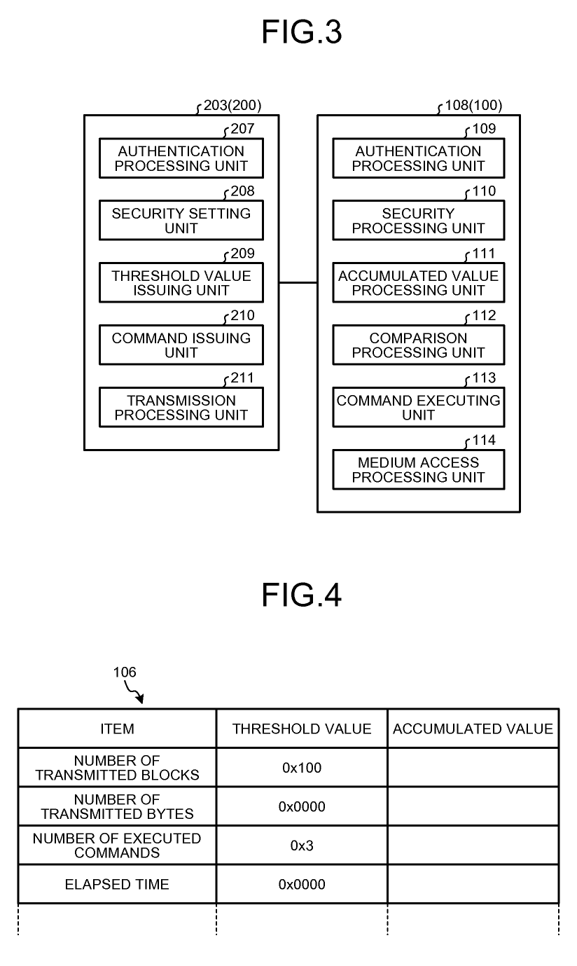

Next, an example of a functional configuration implemented by the processor 108 of the storage device 100 and the CPU 203 of the host devices 200 according to the embodiment executing a predetermined program will be described with reference to FIG. 3.

As illustrated in FIG. 3, the processor 108 of the storage device 100 reads a predetermined program from the ROM 104 and executes the program on the RAM 105, so that the processor 108 includes an authentication processing unit 109, a security processing unit 110, an accumulated value processing unit 111, a comparison processing unit 112, a command executing unit 113, and a medium access processing unit 114. In addition, the CPU 203 of the host device 200 reads a predetermined program from the ROM 204 and executes the program on the RAM 205, so that the CPU 203 includes an authentication processing unit 207, a security setting unit 208, a threshold value issuing unit 209, a command issuing unit 210, and a transmission processing unit 211.

The authentication processing unit 109 of the storage device 100 and the authentication processing unit 207 of the host device 200 execute an authentication process between the storage device 100 and the host device 200. As an authentication method, any method may be used. Herein, a method using authentication data (for example, PIN (Personal Identification Number)) is used as the authentication method.

Namely, in the embodiment, the authentication processing unit 207 of the host device 200 transmits predetermined authentication data (password) to the storage device 100 in order to obtain permission to access the storage medium 102 of the storage device 100. Next, in the case where the authentication data received from the host devices 200 are matched with a code which is set in advance, the authentication processing unit 109 of the storage device 100 determines that the authentication is successful and gives the permission to access the storage medium 102 to the host devices 200. On the other hand, in the case where the authentication data received from the host devices 200 are not matched with the code which is set in advance, the authentication processing unit 109 determines that the authentication is unsuccessful and notifies an error to the host device 200.

The security processing unit 110 of the storage device 100 controls a security state of the storage medium 102. More specifically, the security processing unit 110 is configured to be capable of setting the storage medium 102 to at least two types of states (first state and second state). Herein, the first state is defined as a locked state where access from an outside is restricted, and the second state is defined as an unlocked state where restriction of the access is released. In the embodiment, restriction of the access may be executed every area of the storage medium 102. Namely, the security processing unit 110 is configured to be capable of controlling the access restriction state of at least a portion of an area of the storage medium 102. Meanwhile, in the case where the host device 200 which is not authenticated by the authentication processing unit 109 tries to access a portion of an area of the storage medium 102 which is set to a locked state, the security processing unit 110 notifies an error to the host device 200.

The security setting unit 208 of the host device 200 outputs instruction on the security of the storage medium 102. For example, in the case where the portion of the area of the storage medium 102 is set to a locked state, the security setting unit 208 outputs an instruction indicating releasing the locked state to be changed into the unlocked state. In the case of receiving this instruction, the security processing unit 110 of the storage device 100 executes a process of changing the portion of the area set to the locked state into the unlocked state.

Herein, in the embodiment, the security processing unit 110 of the storage device 100 is configured: to change the portion of the area of the storage medium 102 from the locked state to the unlocked state in response to the instruction of the host device 200; and after that, to return (re-lock) the portion of the area from the unlocked state to the locked state in the case where a predetermined condition is satisfied. The relocking process is implemented by: the accumulated value processing unit 111 and the comparison processing unit 112 of the storage device 100; and the threshold value issuing unit 209 of the first host device.

The threshold value issuing unit 209 of the host device 200 is configured to issue first information defining a relocking condition and to notify the issued first information to the storage device 100. The first information is issued when the instruction, which indicates changing the state of the portion of the area of the storage medium 102 from the locked state into the unlocked state, is output from the security setting unit 208. Hereinafter, the first information will be described more in detail.

The first information according to the embodiment includes a threshold value. The threshold value includes: a first threshold value corresponding to a transmission amount of data to the storage medium 102; a second threshold value corresponding to the number of processes which the host devices 200 executes with respect to the storage medium 102; and a third threshold value corresponding to an elapsed time. After the security processing unit 110 of the storage device 100 receives the first information including these threshold values, in the case where the relocking condition is satisfied, the security setting unit 110 returns the area set to the unlocked state to the locked state. It is determined based on a result of comparison of the threshold value and a first value whether or not the relocking condition is satisfied. The first value is a value with respect to (relating to) the area of the storage medium 102 which is set to the unlocked state in response to the instruction of the host devices 200, and as described hereinafter, the first value is calculated by the accumulated value processing unit 111 of the storage device 100.

In the case where the portion of the area of the storage medium 102 is changed from the locked state into the unlocked state in response to the instruction of the host device 200, the accumulated value processing unit 111 of the storage device 100 calculates the first value with respect to the area in the unlocked state. Next, the comparison processing unit 112 of the storage device 100 compares the first value calculated by the accumulated value processing unit 111 with the threshold value notified by the threshold value issuing unit 209 of the host device 200, and the security processing unit 110 changes the security state of the storage medium 102 based on a result of the comparison.

For example, in the case where the first threshold value is notified, the accumulated value processing unit 111 accumulates the transmission amount of the first data when it is determined that data (hereinafter, referred to as first data) with respect to the area of the storage medium 102 set to the unlocked state are to be transmitted, and then the accumulated value processing unit 111 calculates the accumulated value as the first value. Next, in the case where the accumulated value (first value) of the transmission amount of the first data exceeds the first threshold value, the comparison processing unit 112 returns the area of the storage medium 102 set to the unlocked state to the locked state. In other words, the comparison processing unit 112 sets the area of the storage medium 102 from the unlocked state to the locked state according to the first value exceeding the first threshold value.

As the first threshold value, for example, a data amount (transmission amount) of the first data is set. The first data is data scheduled to be transmitted according to a command issued by one host devices 200 (hereinafter, referred to as a first host device) which issues the instruction indicating changing the portion of the area of the storage medium 102 into the unlocked state. The command includes a first process such as a read command, a write command, or the like. Meanwhile, the first process may include any process executed together with the access to the portion of the area of the storage medium 102 set to the unlocked state.

As described above, as the first threshold value, an amount of data, which the first host device is scheduled to read from the storage medium 102 or to write in the storage medium 102 in the execution of the first process, is set. Accordingly, at the timing when the transmission amount of the first data reaches the amount of data (first threshold value) designated by the first host device, the storage medium 102 can be returned from the unlocked state to the locked state. As a result, even after the transmission amount of the first data reaches the first threshold value, it is possible to avoid the storage medium 102 being still set to the unlocked state. In this manner, it is possible to avoid a host device 200 (hereinafter, referred to as a second host device) other than the first host device being accessible to the storage medium 102.

As another example, in the case where the second threshold value is notified, when it is determined that the first process is to be executed on the area of the storage medium 102 set to the unlocked state, the accumulated value processing unit 111 accumulates the number of execution times of the first process and calculates the accumulated value as the first value. Next, in the case where the first value, which is the accumulated value of the number of execution times of the first process, exceeds the second threshold value, the comparison processing unit 112 returns the area of the storage medium 102 set to the unlocked state to the locked state. In other words, the comparison processing unit 112 sets the area of the storage medium 102 from the unlocked state to the locked state according to the first value exceeding the second threshold value.

As the second threshold value, for example, the number of first processes included in the command issued by the first host device is set. Accordingly, at the timing when all the first processes included in the command from the first host device are completed, the storage medium 102 can be returned from the unlocked state to the locked state. As a result, even after all the first processes are completed, it is possible to avoid the storage medium 102 being still set to the unlocked state. In this manner, it is possible to avoid the second host device other than the first host device being accessible to the storage medium 102.

As still another example, in the case where the third threshold value is notified, the accumulated value processing unit 111 calculates as the first value a time elapsed after the storage medium 102 is set to the unlocked state. Next, in the case where the elapsed time (first value) exceeds the third threshold value, the comparison processing unit 112 returns the area of the storage medium 102 set to the unlocked state to the locked state. In other words, the comparison processing unit 112 sets the area of the storage medium 102 from the unlocked state to the locked state according to the first value exceeding the third threshold value.

As the third threshold value, for example, a time required to execute the command issued by the first host device is set. Accordingly, at the timing when the execution of the command issued by the first host device is completed, the storage medium 102 can be returned from the unlocked state to the locked state. As a result, even after the execution of the command from the first host device is completed, it is possible to avoid the storage medium 102 being still to the unlocked state. In this manner, it is possible to avoid the second host device other than the first host device being accessible to the storage medium 102.

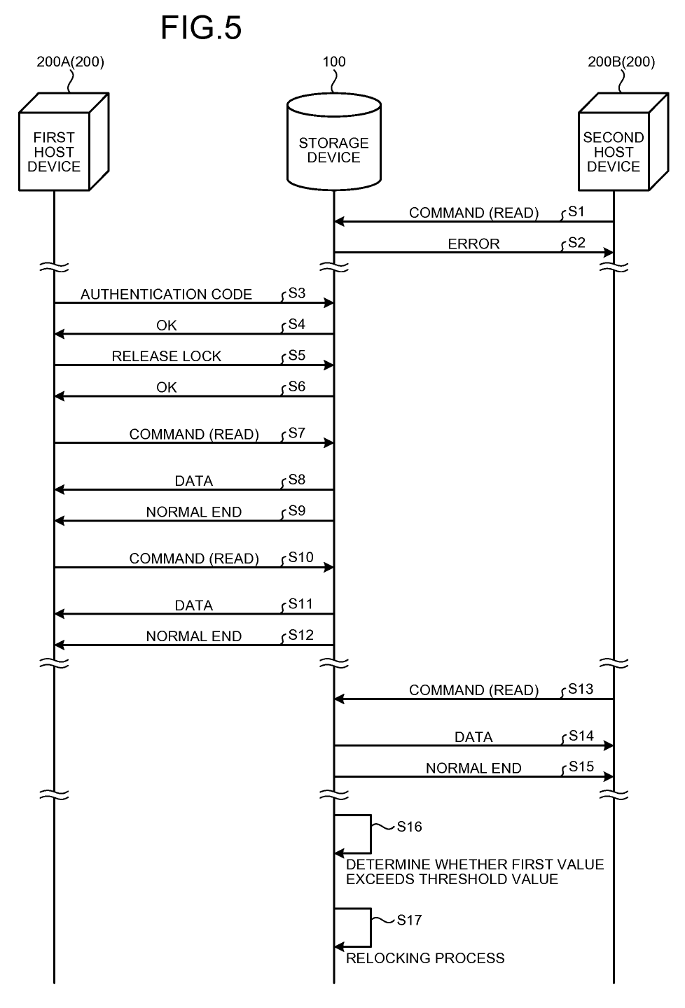

In addition, in the embodiment, in the case where the first information including the threshold value is notified, the comparison processing unit 112 of the storage device 100 generates a table 106 (refer to FIG. 4) storing therein the notified threshold value and the first value calculated by the accumulated value processing unit 111 in a correspondence manner. Next, the comparison processing unit 112 compares the threshold value and the first value by using the table 106.

In the table 106 illustrated in FIG. 4, the “number of transmitted blocks” and the “number of transmitted bytes” are listed as items corresponding to the first threshold value, the “number of executed commands” is listed as an item corresponding to the second threshold value, and the “elapsed time” is listed as an item corresponding to the third threshold value. In this manner, in the embodiment, a combination of the first to third threshold values can be used. Of course, the first to third threshold values may also be separately used.

As described above, in the embodiment, the process of returning the storage medium 102 from the unlocked state to the locked state is executed based on the result of comparison of the first value and the threshold value irrespective of the instruction from the host device 200. Namely, in the embodiment, in the case where the first value exceeds the threshold value, even while the command with respect to the area of the storage medium 102 set to the unlocked state is executed, the comparison processing unit 112 allows the security processing unit 110 to execute the process of relocking the storage medium 102.

That is, in the embodiment, in the case where the portion of the area of the storage medium 102 is set to the unlocked state in response to the instruction from the first host device, the area set to the unlocked state is accessible from the second host device other than the first host device as well as the first host device. Therefore, for example, in the case where the first threshold value corresponding to the transmission amount or the second threshold value corresponding to the number of execution times of the first process is used, even while the first process is executed in response to the command issued by the first host device, if the second host device issues the same command, the first value which is the accumulated value of the transmission amount or the accumulated value of the number of execution times of the first process may be increased.

Therefore, in the embodiment, while the first host device executes the access to the area of the storage medium 102 set to the unlocked state, in the case where the first value exceeds the threshold value, the security processing unit 110 notifies an error to the first host device. The error is to notify a message indicating that the second host device other than the first host device executes the same access. According to the error, the first host device recognizes that there is an access of the second host device to the storage medium 102 to which the first host device releases restriction of the access.

Returning to FIG. 3, the command issuing unit 210 of the host device 200 issues a command with respect to the storage device 100 (the command may include a command instructing the execution of the first process such as read or write). The transmission processing unit 211 of the host device 200 controls data communication (transmission) between the storage device 100 and the host device 200. The command executing unit 113 of the storage device 100 executes the command received from the host device 200. The medium access processing unit 114 of the storage device 100 controls the access to the storage medium 102 in the case where the command executed by the command executing unit 113 requires the access to the storage medium 102.

In the above description, an example where each module of FIG. 3 is implemented by a collaboration of the software (program) and the hardware (processor 108 and CPU 203) is described. However, each module of FIG. 3 may be implemented by only the hardware. Namely, in the embodiment, dedicated hardware (circuitry) corresponding to each module of FIG. 3 may be provided in the storage device 100 and the host device 200.

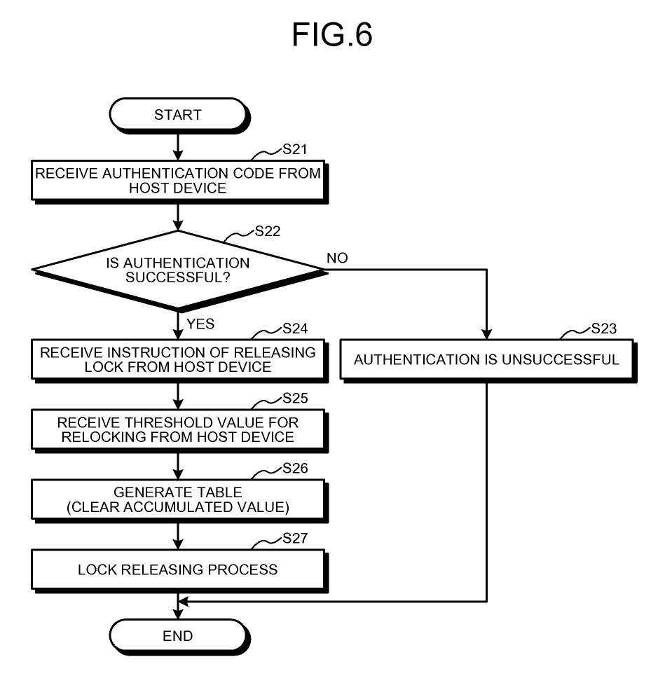

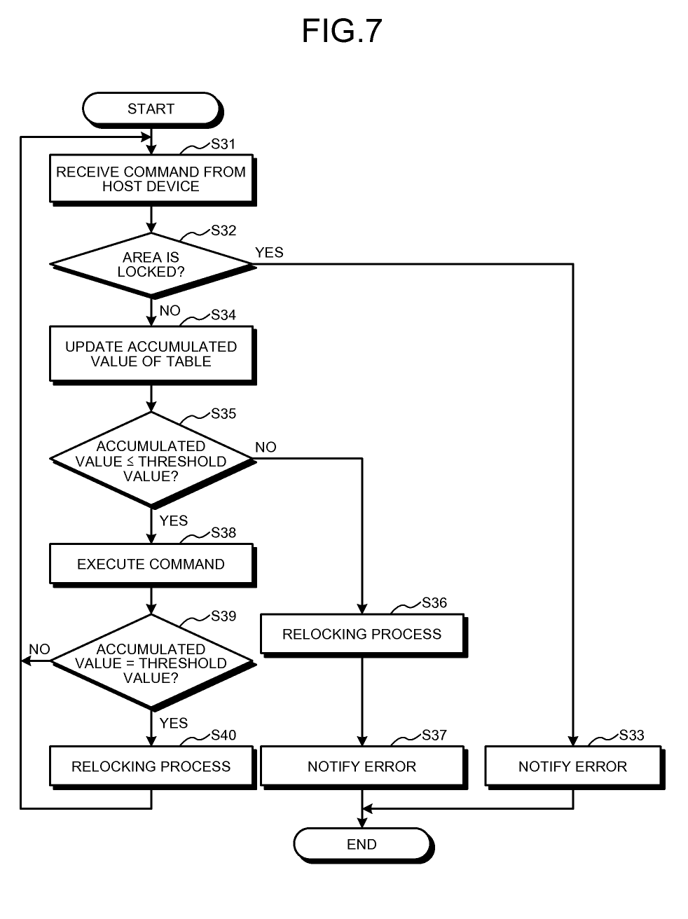

Next, an outline of the processes executed by the storage device 100 and the host devices 200 according to the embodiment will be described with reference to FIG. 5. Herein, the processes will be described in brief because the process of the first host device issuing the threshold value, the process of the storage device 100 comparing the threshold value and the first value, or the like will be described in detail later with reference to FIGS. 6 and 7. In FIG. 5, for the convenience, the first host device which is the host devices 200 acquiring authentication of the storage device 100 and releasing restriction of the access to the storage device 100 is denoted by reference numeral 200A, and the second host device which is the host devices 200 other than the first host device is denoted by the reference numeral 200B.

First, the process in the case of the second host device 200B reading data from the storage medium 102 of the storage device 100 will be described with reference to S1 and S2. Herein, the storage medium 102 of the storage device 100 is assumed to be set to the locked state where the access is restricted. In this case, at S1, the command issuing unit 210 of the second host device 200B issues the command corresponding to read and transmits the issued command to the storage device 100. However, the second host device 200B does not acquire authentication of the storage device 100 and the storage medium 102 is set to the locked state. Therefore, at S2, the authentication processing unit 109 of the storage device 100 notifies an error indicating that there is no authority for accessing the storage medium 102 to the second host device 200B.

Next, the process in the case of the first host device 200A changing the storage medium 102 of the storage device 100 from the locked state to the unlocked state will be described with reference to S3 to S6. In the case where the state of the storage medium 102 is changed in this manner, as illustrated in S3 and S4, the first host device 200A needs to acquire authentication of the storage device 100.

At S3, the authentication processing unit 207 of the first host device 200A transmits the authentication data together with an authentication request to the storage device 100. At S4, the authentication processing unit 109 of the storage device 100 determines whether or not the authentication data received from the first host device 200A are matched with a code which is set in advance. In the case where the authentication data and the code are matched with each other, the authentication processing unit notifies a message (OK) indicating that the authentication is successful to the first host device 200A.

In the case where S3 and S4 are completed, at S5, the security setting unit 208 of the first host device 200A transmits instruction (lock release instruction) of releasing restriction of the access of the storage medium 102 to the storage device 100. At this time, the first host device 200A transmits the threshold value (first information) defining the condition for allowing the storage device 100 to execute the relocking process. At S6, the security processing unit 110 of the storage device 100 releases restriction of the access in response to the instruction of the first host device 200A, and notifies a message (OK) indicating that the release of restriction of the access is successful to the first host device 200A.

In the case where S3 to S6 are completed, it is possible to freely access the area of the storage medium 102 of the storage device 100 to which restriction of the access is released. Hereinafter, the process in the case of the first host device 200A reading the data from the area of the storage medium 102 to which restriction of the access is released will be described with reference to S7 to S9.

At S7, the command issuing unit 210 of the first host device 200A issues the command corresponding to read and transmits the issued command to the storage device 100. As described above, the first host device 200A acquires authentication of the storage device 100 and the storage medium 102 is set to the unlocked state. Therefore, at S8, the command executing unit 113 and the medium access processing unit 114 of the storage device 100 and the transmission processing unit 211 of the first host device 200A execute transmission of data which are to be the read object. In the case where it is determined that data are to be transmitted, the storage device 100 accumulates, for example, the data amount (transmission amount) which is scheduled to be transmitted and calculates the accumulated value as the first value. In the case where the transmission of data is completed, at S9, the storage device 100 notifies a message (OK) indicating that the transmission of data is completed to the first host device 200A.

Meanwhile, in the case where the storage medium 102 of the storage device 100 is still set to the unlocked state even after S7 to S9 are completed, as illustrated in S10 to S12, the first host device 200A can continue to read data from the storage medium 102. Namely, at S10, the command issuing unit 210 of the first host device 200A issues a command corresponding to read and transmits the issued command to the storage device 100. At S11, the command executing unit 113 and the medium access processing unit 114 of the storage device 100 and the transmission processing unit 211 of the first host device 200A execute transmission of data which are to be the read object. According to the transmission of data executed, the first value (accumulated value) is updated. In the case where the transmission of data is completed, at S12, the storage device 100 notifies a message (OK) indicating that the data transmission is completed to the first host device 200A.

Furthermore, in the case where the storage medium 102 of the storage device 100 is still set to the unlocked state even after S10 to 12 are completed, as illustrated in S13 to S15, the second host device 200B can also read data from the storage medium 102. Namely, at S13, the command issuing unit 210 of the second host device 200B issues a command corresponding to read and transmits the issued command to the storage device 100. At S14, the command executing unit 113 and the medium access processing unit 114 of the storage device 100 and the transmission processing unit 211 of the second host device 200B execute transmission of data which are to be the read object. According to the transmission of data executed herein, the first value (accumulated value) is updated. In the case where the transmission of data is completed, at S15, the storage device 100 notifies a message (OK) indicating that the data transmission is completed to the second host device 200B.

Next, processes in the case of the storage device 100 executing the relocking process by using the threshold value notified by the first host device 200A will be described in brief with reference to S16 and S17. At S16, the storage device 100 determines whether or not the calculated first value exceeds the threshold value notified by the first host device 200A. In the case where it is determined that the first value exceeds the threshold value, at S17, the storage device 100 executes the relocking process, that is, the process of setting the portion of the area of the storage medium 102 set to the unlocked state to the locked state again. In the case where S16 and S17 are completed, it is not possible for the first host device 200A or the second host device 200B to freely access the storage medium 102 of the storage device 100.

Meanwhile, in the embodiment, besides the case of executing the relocking process, there is a case where the storage device 100 sets the storage medium 102 from the unlocked state to the locked state in response to the instruction (lock command) from the first host device 200A. In this case, similarly to S3 and S4, the first host device 200A needs to acquire authentication of the storage device 100.

Namely, before transmitting the lock command, the authentication processing unit 207 of the first host device 200A transmits the authentication data together with the authentication request to the storage device 100 and acquires authentication of the authentication processing unit 109 of the storage device 100. In the case where the authentication is completed, the security setting unit 208 of the first host device 200A transmits the lock command to the storage device 100. And then, the security processing unit 110 of the storage device 100 sets restriction of the access in response to the lock command and notifies the message indicating that setting of restriction of the access is successful to the first host device 200A. In the case where this process is completed, it is not possible for the first host device 200A or the second host device 200B to freely access the storage medium 102 of the storage device 100.

Next, a process of the storage device 100 according to the embodiment releasing restriction of the access to the storage medium 102 in response to the instruction from the host devices 200 will be described with reference to FIG. 6.

In the process flow of the FIG. 6, at S21, the authentication processing unit 109 of the storage device 100 receives the authentication data transmitted from the authentication processing unit 207 of the host device 200.

At S22, the authentication processing unit 109 of the storage device 100 determines whether or not the authentication data received at S21 are matched with a code which is set in advance. Namely, the authentication processing unit 109 determines whether or not the authentication with respect to the host device 200 is successful.

At S22, in the case where it is determined that the authentication is not successful, the process proceeds to S23. At S23, the authentication processing unit 109 of the storage device 100 notifies an error indicating that the authentication is unsuccessful to the host device 200. Then, the process is ended.

On the other hand, at S22, in the case where it is determined that the authentication is successful, the process proceeds to S24. At S24, the security processing unit 110 of the storage device 100 receives the instruction (lock release instruction) indicating releasing restriction of the access to the storage medium 102 and transmitted from the security setting unit 208 of the host devices 200. In addition to the lock release instruction, the threshold value as the first information defining the condition of relocking the storage medium 102 is also transmitted from the host device 200 to the storage device 100.

At S25, the comparison processing unit 112 of the storage device 100 receives the threshold value for the relocking transmitted from the threshold value issuing unit 209 of the host device 200. As described above, as the threshold value, there is a first threshold value corresponding to the transmission amount of the data in the storage medium 102, a second threshold value corresponding to the number of processes executed by the host devices 200, a third threshold value corresponding to a time, or the like. S25 may be executed before S24.

At S26, the comparison processing unit 112 of the storage device 100 generates a table 106 (refer to FIG. 4) storing therein the threshold value received at S25. The table 106 also stores therein the accumulated value calculated (counted) by the accumulated value processing unit 111 as the comparison object of the threshold value. In the case where the table 106 has already been generated and a previous accumulated value is stored in the generated table 106, at S26, the comparison processing unit 112 resets or invalidates the previous accumulated value stored in the table 106.

At S27, the security processing unit 110 of the storage device 100 changes the portion of the area of the storage medium 102 designated by the host devices 200 from the locked state into the unlocked state to release restriction (lock) of the access to the area. Then, the process is ended.

Next, a process in the case of the storage device 100 according to the embodiment controlling the access restriction state of the storage medium 102 by using the table 106 will be described with reference to FIG. 7.

In the process flow of FIG. 7, at S31, the command executing unit 113 of the storage device 100 receives the command transmitted from the command issuing unit 210 of the host device 200. The command may include the first process executed together with the access to the storage medium 102 such as read or write.

At S32, the comparison processing unit 112 of the storage device 100 checks the access restriction state of the portion of the area of the storage medium 102 which is the access target at the time of executing the command received at S31. Namely, at S32, the comparison processing unit 112 determines whether the area which is the access target is set to locked state or to the unlocked state.

At S32, in the case where the area which is the access target is set to the locked state, the process proceeds to S33. In this case, since the access to the area which is the access object is restricted. Therefore, at S33, the security processing unit 110 of the storage device 100 notifies an error indicating that there is no authority for accessing the area which is the access target (or an error indicating that the access to the area which is the access target is restricted) to the host device 200. Then, the process is ended.

On the other hand, at S32, in the case where it is determined that the area which is the access target is set to the unlocked state, the process proceeds to S34. At S34, the accumulated value processing unit 111 of the storage device 100 updates the accumulated value of the table 106 (refer to FIG. 4).

For example, in the case where the first threshold value corresponding to the transmission amount of the data in the storage medium 102 is used as the threshold value, at S34, the accumulated value processing unit 111 accumulates the transmission amount of the first data with respect to the area of the storage medium 102 set to the unlocked state, and the accumulated value processing unit 111 updates the table 106 by using the accumulated value. Similarly, in the case where the second threshold value corresponding to the number of processes executed by the host devices 200 is used as the threshold value, at S34, the accumulated value processing unit 111 accumulates the number of execution times of the first process executed together with the access to the storage medium 102, and the accumulated value processing unit 111 updates the table 106 by using the accumulated value. Similarly, in the case where the third threshold value corresponding to the time is used as the threshold value, at S34, the accumulated value processing unit 111 updates the table 106 by using the time elapsed after the storage medium 102 is set to the unlocked state as the accumulated value.

At S35, the comparison processing unit 112 of the storage device 100 determines with reference to the table 106 whether or not the accumulated value is equal to or less than the threshold value.

At S35, in the case where it is determined that the accumulated value is more than the threshold value, the process proceeds to S36. As described above, generally, the threshold value is set so as to be equal to the accumulated value in the case where the condition, which is designated by the first host device issuing the instruction indicating releasing restriction of the access to the storage medium 102, is satisfied. For this reason, in the case where it is determined at S35 that the accumulated value is more than the threshold value, it may be estimated that the access of second host device other than the first host device is executed at any timing before the condition designated by the first host device is satisfied by the access of the first host device.

Therefore, in the case where it is determined in S35 that the accumulated value is more than the threshold value, at S36, the security processing unit 110 of the storage device 100 executes the process (relocking process) of returning the area of the storage medium 102 set to the unlocked state to the locked state. At S37, the security processing unit 110 notifies an error indicating that the second host device other than the first host device executes the access to the area set to the unlocked state, or simply notifies an error indicating the relocking to the first host device. Then, the process is ended.

On the other hand, in the case where it is determined at S35 that the accumulated value is equal to less than the threshold value, the process proceeds to S38. At S38, the command executing unit 113 of the storage device 100 executes the command received at S31.

At S39, the comparison processing unit 112 of the storage device 100 determines with reference to the table 106 whether or not the accumulated value is equal to the threshold value. Namely, the comparison processing unit 112 determines whether or not the condition designated by the first host device is satisfied.

In the case where it is determined at S39 that the accumulated value is not equal to the threshold value, since the condition designated by the first host device is not satisfied, the process returns to S31. On the other hand, in the case where it is determined at S39 that the accumulated value is equal to the threshold value, since the condition designated by the first host device is satisfied, the process proceeds to S40.

At S40, the security processing unit 110 of the storage device 100 executes a process (relocking process) of returning the area of the storage medium 102 set to the unlocked state to the locked state. Then, the process is ended.

As described heretofore, the processor 108 of the storage device 100 according to the embodiment is configured to be capable of setting the portion of the area of the storage medium 102 to the first state (locked state) where the access is restricted or to the second state (unlocked state) where restriction of the access is released. The processor 108 receives the instruction of setting the portion of the area to the unlocked state and the first information from the first host device among the plurality of the host devices 200, and the processor 108 sets the portion of the area to the unlocked state in response to the received instruction. Here, the first information defines the condition of setting the portion of the area from the unlocked state to the locked state again. After the portion of the area is set to the unlocked state in response to the instruction, the processor sets the portion of the area from the unlocked state to the locked state again based on the received first information. Accordingly, even in the configuration where the storage device 100 can be communicatably connected to the plurality of the host devices 200 via the expanders 300, it is possible to appropriately control the access restriction state of the storage medium 102 by using the first information notified by the first host device which issues the instruction indicating changing the access restriction state of the storage medium 102.

### Modifications

The technique of the embodiment can be applied to the case where all the host devices which are communicatably connected to the storage device do not have the functional configuration of FIG. 3. Namely, although all the host devices cannot issue the threshold value as the first information, at least one of the host devices may issue the threshold value. In this case, if the host device (for the convenience, referred to as a management host) which has the function of issuing the threshold value issues the threshold value and releases restriction of the access to the storage device, even though the management host is powered off after that, the restriction of the access can be executed to the storage device. Specifically, the restriction of the access can be executed without monitoring the state of access to the storage device in the case where the number of access times of the host devices, the time elapsed after restriction of the access, or the like reaches the threshold value.

In addition, the technique of the embodiment can be applied to a system which does not include an expander as a relay device. For example, if the storage device corresponds to a dual port of SAS, the storage device can be connected to a plurality (at least two) of host devices without any expander. In this system, if the storage medium is allowed to execute controlling using the first information defining the relocking condition, it is possible to obtain the same effects as those of the embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device comprising:
a storage medium;
an interface connectable to a plurality of host devices; and
a processor configured:
to be capable of setting a portion of an area of the storage medium to a first state where access is restricted or to a second state where restriction of the access is released;
to receive, from a first host device among the host devices, an instruction of setting the portion of the area to the second state and first information defining a condition of setting the portion of the area from the second state to the first state again;
to set the portion of the area to the second state in response to the instruction; and
to set, after the portion of the area is set to the second state in response to the instruction, the portion of the area from the second state to the first state again based on the first information.

2. The storage device of claim 1, wherein
the first information comprises a threshold value, and
the processor is configured to set the portion of the area from the second state to the first state according to a first value exceeding the threshold value, the first value being a value with respect to the portion of the area set to the second state.

3. The storage device of claim 2, wherein
the processor is configured to notify a message to the first host device in case where the first value exceeds the threshold value, the message indicating that a second host device other than the first host device executes access to the portion of the area.

4. The storage device of claim 2, wherein
the threshold value comprises a first threshold value corresponding to a transmission amount of data with respect to the portion of the area, and
the processor is configured:
to calculate an accumulated value of the transmission amount of the data as the first value, the accumulated value being accumulated according to the transmission of the data with respect to the portion of the area set to the second state in response to instructions from the host devices; and
to set the portion of the area from the second state to the first state in case where the accumulated value exceeds the first threshold value.

5. The storage device of claim 2, wherein
the threshold value comprises a second threshold value corresponding to number of times of a process executed with respect to the portion of the area, and
the processor is configured:
to calculate an accumulated value of number of times of a first process as the first value, the first process being executed together with access to the portion of the area set to the second state, the accumulated value being accumulated according to executions of the first process in response to instructions from the host devices; and
to set the portion of the area from the second state to the first state in case where the accumulated value exceeds the second threshold value.

6. The storage device of claim 2, wherein
the threshold value comprises a third threshold value corresponding to a time, and
the processor is configured:
to calculate a time elapsed after the portion of the area is set to the second state as the first value; and
to set the portion of the area from the second state to the first state in case where the elapsed time exceeds the third threshold value.

7. The storage device of claim 2, wherein
the processor is configured:
to generate a table to store therein the threshold value and the first value in a correspondence manner; and
to compare the threshold value and the first value by using the table.

8. A system comprising a plurality of host devices and a storage device, wherein
the storage device comprises:
a storage medium;
an interface connectable to the plurality of host devices; and
a processor configured:
to be capable of setting a portion of an area of the storage medium to a first state where access is restricted or to a second state where restriction of the access is released;
to receive, from a first host device among the host devices, an instruction of setting the portion of the area to the second state and first information defining a condition of setting the portion of the area from the second state to the first state again;
to set the portion of the area to the second state in response to the instruction; and
to set, after the portion of the area is set to the second state in response to the instruction, the portion of the area from the second state to the first state again based on the first information.

9. The system of claim 8, wherein
the first information comprises a threshold value, and
the processor is configured to set the portion of the area from the second state to the first state according to a first value exceeding the threshold value, the first value being a value with respect to the portion of the area set to the second state.

10. The system of claim 9, wherein
the processor is configured to notify a message to the first host device in case where the first value exceeds the threshold value, the message indicating that a second host device other than the first host device executes access to the portion of the area.

11. The system of claim 9, wherein
the threshold value comprises a first threshold value corresponding to a transmission amount of data with respect to the portion of the area, and
the processor is configured:
to calculate an accumulated value of the transmission amount of the data as the first value, the accumulated value being accumulated according to the transmission of the data with respect to the portion of the area set to the second state in response to instructions from the host devices; and
to set the portion of the area from the second state to the first state in case where the accumulated value exceeds the first threshold value.

12. The system of claim 9, wherein
the threshold value comprises a second threshold value corresponding to number of times of a process executed with respect to the portion of the area, and
the processor is configured:
to calculate an accumulated value of number of times of a first process as the first value, the first process being executed together with access to the portion of the area set to the second state, the accumulated value being accumulated according to executions of the first process in response to instructions from the host devices; and
to set the portion of the area from the second state to the first state in case where the accumulated value exceeds the second threshold value.

13. The system of claim 9, wherein
the threshold value comprises a third threshold value corresponding to a time, and
the processor is configured:
to calculate a time elapsed after the portion of the area is set to the second state as the first value; and
to set the portion of the area from the second state to the first state in case where the elapsed time exceeds the third threshold value.

14. The system of claim 9, wherein
the processor is configured:
to generate a table to store therein the threshold value and the first value in a correspondence manner; and
to compare the threshold value and the first value by using the table.

15. A method of a storage device comprising a storage medium and an interface connectable to a plurality of host devices, the method comprising:
setting a portion of an area of the storage medium to a first state where access is restricted or a second state where restriction of the access is released;
receiving, from a first host device among the host devices, an instruction of setting the portion of the area to the second state and first information defining a condition of setting the portion of the area from the second state to the first state again;
setting the portion of the area to the second state in response to the instruction; and
after the portion of the area is set to the second state in response to the instruction, setting the portion of the area from the second state to the first state again based on the first information.

16. The method of claim 15, wherein
the first information comprises a threshold value, and
the method further comprises setting the portion of the area from the second state to the first state according to a first value exceeding the threshold value, the first value being a value with respect to the portion of the area set to the second state.

17. The method of claim 16, further comprising: notifying a message to the first host device in case where the first value exceeds the threshold value, the message indicating that a second host device other than the first host device executes access to the portion of the area.

18. The method of claim 16, wherein
the threshold value comprises a first threshold value corresponding to a transmission amount of data with respect to the portion of the area, and
the method further comprises:
calculating an accumulated value of the transmission amount of the data as the first value, the accumulated value being accumulated according to the transmission of the data with respect to the portion of the area set to the second state in response to instructions from the host devices; and
setting the portion of the area from the second state to the first state in case where the accumulated value exceeds the first threshold value.

19. The method of claim 16, wherein
the threshold value comprises a second threshold value corresponding to number of times of a process executed with respect to the portion of the area, and
the method further comprises:
calculating an accumulated value of number of times of a first process as the first value, the first process being executed together with access to the portion of the area set to the second state, the accumulated value being accumulated according to executions of the first process in response to instructions from the host devices; and
setting the portion of the area from the second state to the first state in case where the accumulated value exceeds the second threshold value.

20. The method of claim 16, wherein
the threshold value comprises a third threshold value corresponding to a time, and
the method further comprises:
calculating a time elapsed after the portion of the area is set to the second state as the first value; and
setting the portion of the area from the second state to the first state in case where the elapsed time exceeds the third threshold value.
